(19) United States
(12) Patent Application Publication
(10) Pub. No.: US 2002/0107700 A1
(43) Pub. Date: Aug. 8, 2002

(54) System and process for capturing, storing, maintaining and reporting information regarding databases via the internet

(76) Inventor: John Barry Cooney, Evanston, IL (US)

Correspondence Address: John B. Cooney, 1715 Chicago Ave. # 915, Evanston, IL, 60201, US

(21) Appl. No.: 09/812,598

(22) Filed: Jun. 29, 2001

Related U.S. Application Data
(60) Provisional application No. 60/205,383, filed on May 19, 2000.

(51) Int. Cl. G06F 17/60

(52) U.S. Cl. 705/1

(57) ABSTRACT

A system and process for capturing, storing, maintaining and reporting data on related informational sources (i.e. databases) that can be used by a customer to determine which databases best fits the customer needs. The information for each database can be updated by the database vendors via secure online forms, or by update programs which read vendor supplied files. System users can search for relevant databases and obtain information about them, such as prices and features, via keyword search or topic drill-down. The system, or meta-index, is relational.

### BACKGROUND

1. Field Of The Invention

This patent relates generally to the field of data search and retrieval, and more particularly to a system and process for capturing and storing information about vendorsponsored databases in a meta-index, enabling the vendors to maintain (update) the information about their own databases, and allowing customers to search the meta-index and generate reports about selected databases.

2. Description Of The Related Art

Many individuals use the Internet to access information about a particular subject of interest. This information is often accessed through proprietary fee-based searchable databases. Typical databases searched and accessed in this way include legal, medical, scientific and market research databases. However, there are so many different databases available to be searched—and more being developed all the time—that it is often difficult for the user doing the searching to determine which database is best for their particular needs. Many times the user is not even aware of the best database to search.

For example, there are approximately 400-600 known legal database vendors, including Reed Elsevier Inc. (owner of LEXIS-NEXIS) and West Group (owner of Westlaw), as well as government agencies, law firms and libraries. Some vendors offer more than one database. West Group alone offers about 500 databases.

One known means for allowing users to find a database is to provide a list of databases with links to each database Internet site. A disadvantage of this type of system is that it provides very little information about the databases in the list beyond the title and general topic of concern. Another problem is that these lists of databases cannot be directly updated by the database vendors themselves. Thus a need exists for a system that can capture information about databases in a particular field of interest, enable the database vendors to update that information themselves, and enable users to access the information and select a database of interest based on the user's individual needs. Optionally, the user can go directly to the database of interest via a “Hyperlink”.

Therefore it is an object of the present invention to provide an efficient and accurate system and process for capturing, maintaining and reporting information on databases in a particular field of interest via the Internet.

It is a further object of the present invention to provide a searchable meta-index that comprises information on related databases so that a user can determine and compare features of the databases to determine which database best fits the user's needs.

A still further object of the present invention is to provide a meta-index that can be automatically updated by a vendor.

Another object of the present invention is to provide a central clearinghouse for capturing, updating and reporting information about various database sources, including topic, type of media and cost.

Yet another object of the present invention is to provide a clearinghouse for databases that costs the database vendor nothing, thereby encouraging their participation.

Further and additional objects will appear from the description, accompanying drawings, and appended claims.

### SUMMARY OF THE INVENTION

The present invention is a system and process for capturing, storing, maintaining and reporting data on related informational sources (i.e. databases) that can be used by a customer to determine which database best fits the customers needs. The information for each database can be loaded and maintained (updated) by the database vendors themselves once they have been assigned a vendor ID and password. The system is secure in that no vendor can gain access to another vendor's files. Vendors may update their own information as often as they wish. Alternatively, the information may be updated automatically by sending a meta data file to the server using the file transfer protocol (FTP) currently available on the Internet, and then running a custom written update program.

By accessing the system, a user can search for relevant databases and obtain information about them. The information can include the name of the database, the name and address of the vendor, a description of the information covered in the database, the type of media in which the information is offered (eg. online, CD-ROM, facsimile), the frequency of updates (update schedule), and the cost of using the database. The system, or meta-index, is relational, i.e., multiple tables of search fields are interconnected by links so a user can move from one table to another. In one anticipated enhancement, the meta-index includes hyperlinks to the databases themselves.

### THE DRAWINGS

FIG. 1 is a block diagram of an embodiment of the present invention, a system for capturing, storing, maintaining and reporting information about databases via the Internet, including a Meta-Database.

FIG. 2 is a Meta Model illustrating the relationship among the eighteen relational tables that make up the Meta Database shown in FIG. 1.

FIG. 3 is a flowchart illustrating the preferred user architecture of the system of the present invention.

FIG. 4 is an example of a vendor maintenance login screen.

FIG. 5 is an example of a maintenance screen used by a vendor to indicate whether the vendor will be entering information about a database for the first time or modifying an old entry.

FIG. 6 is an example of a maintenance screen listing the vendor databases.

FIG. 7 is an example of a maintenance screen used by a vendor to indicate certain relational preferences.

FIG. 8 is an example of a database entry management screen for capturing information about a database from a vendor.

FIG. 9 is an example of a data entry management screen for capturing service information about a database from a vendor.

FIG. 10 is an example of a data entry management screen for capturing price information about a database from a vendor.

FIGS. 11 and 12 are examples of data entry management screens for capturing topic information about a database from a vendor FIG. 13 is an example of a display screen encountered by a user upon first accessing the system.

FIG. 14 is an example of a typical report that might be generated by a system user.

FIG. 15 is an example of a typical detailed report that might be generated by a system user.

FIG. 16 is an example of a display screen encountered by a user during the course of an advanced search using the system.

### DETAILED DESCRIPTION OF THE INVENTION

Internet Websites that enable a user to perform research on a particular topic are becoming increasingly popular. However, the very fact that there are so many sources of information available, both on and off the Internet, can make it difficult for a researcher to locate the best source of information. The purpose of the present invention is to provide an efficient and accurate means to capture, store, maintain and report information about sources of information (i.e. databases) within a particular area of interest so that the user can more easily find and use the best source for his or her purposes. The invention allows the user to specify, via the Internet—a topic of interest, the type of media in which the information exists (eg. on-line or CD-ROM), and other criteria.

### System Architecture

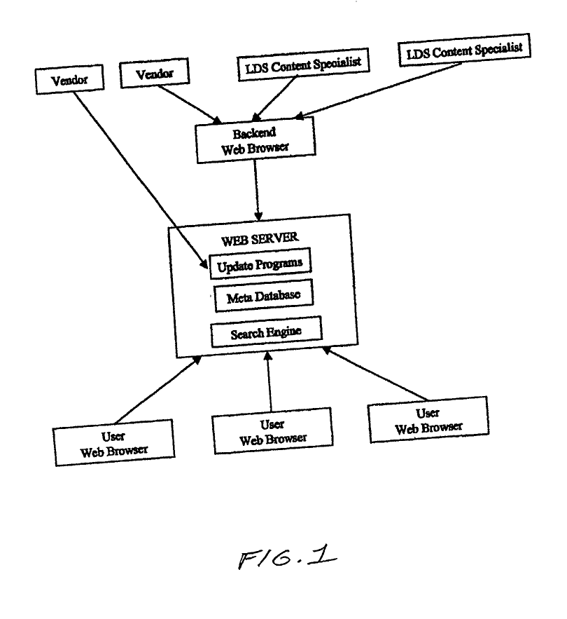

Turning to the drawings, FIG. 1 is a block diagram of an embodiment of the present invention, a system for capturing, storing, maintaining and reporting information about databases via the Internet. The system comprises a Web Server which can be “front end” accessed by a plurality of users. The web server includes a Meta Database for storing information relating to databases, Update Programs for updating the information in the Meta Database by the vendors, and a Search Engine to allow the users to search the Meta Database via each user's own web browser. The Vendors can update their database information either directly, by using the Update Programs, or through a Back End Browser. The system may also be updated by the Web Server host.

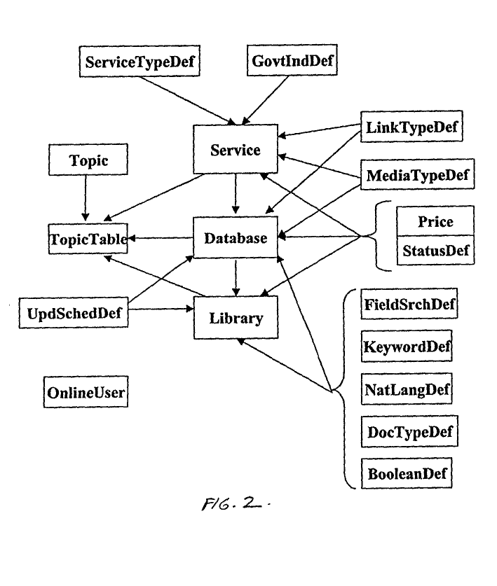

FIG. 2 is a Meta Model illustrating the relationship among the eighteen relational tables that make up the Meta Database. Each table has a unique, primary key. Tables related to other parent tables contain the primary key of the parent. Information sources (databases) are contained in three different tables: Service, Database and Library. Eleven of the tables are small look-up tables that are used to create pull downs for Backend Web Browser fields.

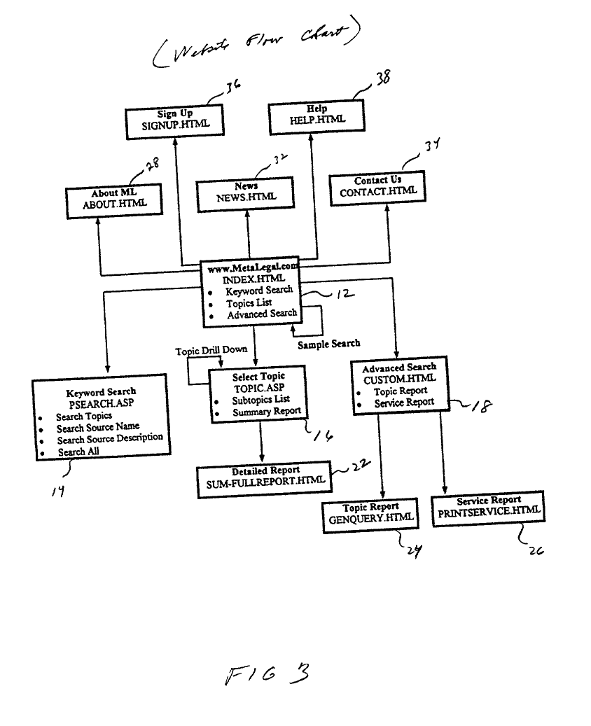

FIG. 3 a flowchart illustrating the preferred software architecture of the system of capturing, storing, maintaining and reporting information about databases via the Internet. To access the system, a user calls up the system web site 12, from which the user can search the repository or Meta-Database (INDEX-HTML) via subroutines for Keyword Searching 14, Select Topic drilldown searching 16, or Advanced Searching 18. A sample search program is also provided for the novice user.

The Select Topic drilldown subroutine 16 can be used to generate a detailed report using a Detailed Report subroutine 22. The Advanced Search subroutine 18 can be generate a topic report via a Topic Report subroutine 24 or a service report using a Service Report subroutine 26.

Other subroutines included in the system 10 include an About subroutine 28 which describes the search process, a News subroutine 32 for announcing recent news of interest to the user, and a subroutine 34 entitled Contact Us. A SignUp subroutine 36 and a Help subroutine 38 are also included in the system narchitecture.

The meta-index comprises multiple tables of information that relate to one another to make it easy for the customer to navigate. The meta-index can be readily modified by the system provider and is scalable.

### How the system is used:

The process for capturing, storing, maintaining and reporting data on various databases in a related field using the Internet is described in more detail below:

### Step 1 (Data Capture):

The meta-index provider contacts vendors to request their participation in loading information about their database(s) onto the meta-index and, if they agree, to set up a URL, User ID and password for them. The vendor may then input data about its databases either manually via the Back End Web Browser (FIG. 1), or by transferring files using the Update Programs available through the Hosts Web Server.

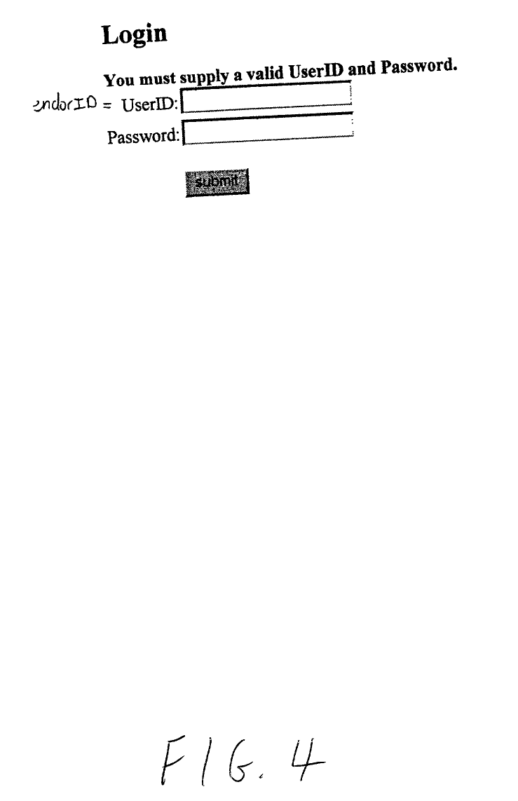

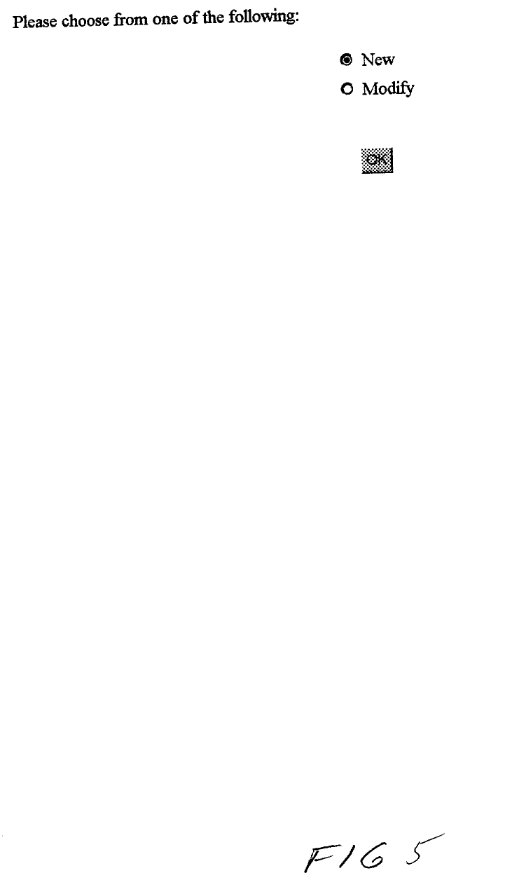

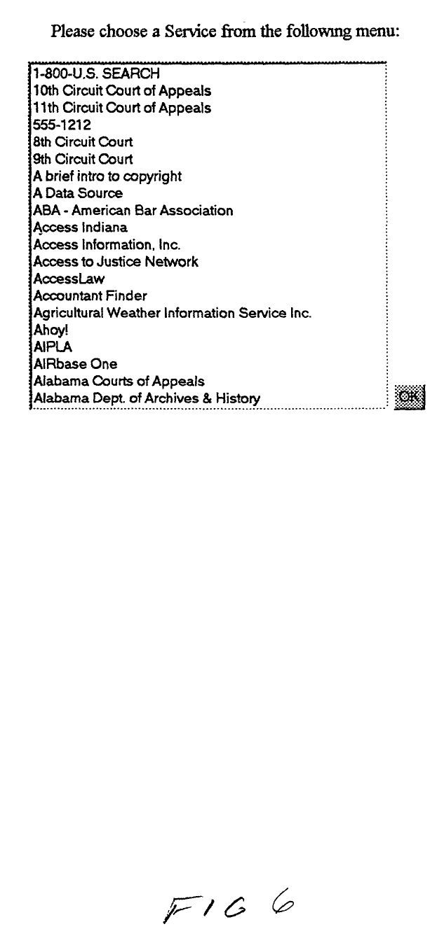

When using the secure Back End Browser, the first screen a vendor sees is a log-in screen (FIG. 4) which requires the vendor to enter its User ID and password. Thus each vendor only has access to its own services data. There is no cost to the database vendor for posting information about their database in the meta-index, thus encouraging more vendors to participate. Users benefit by having a greater number of databases to search and select from.

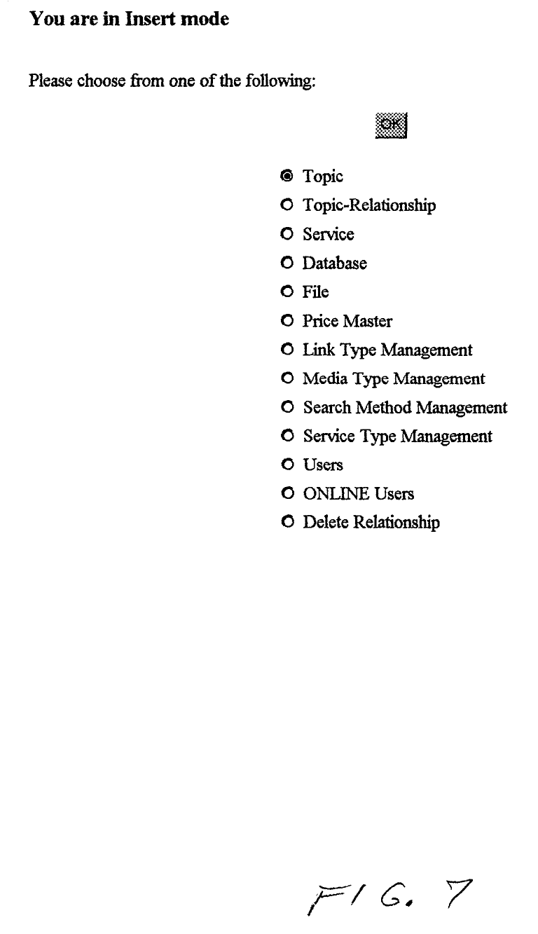

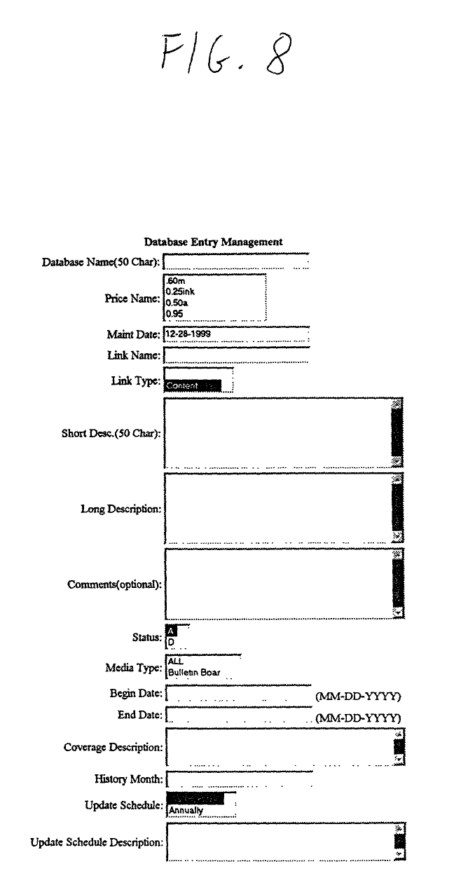

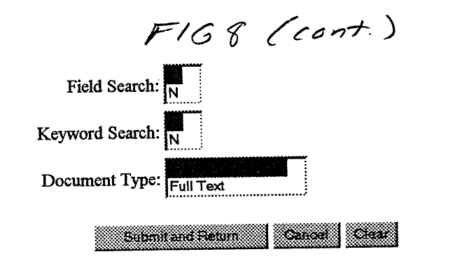

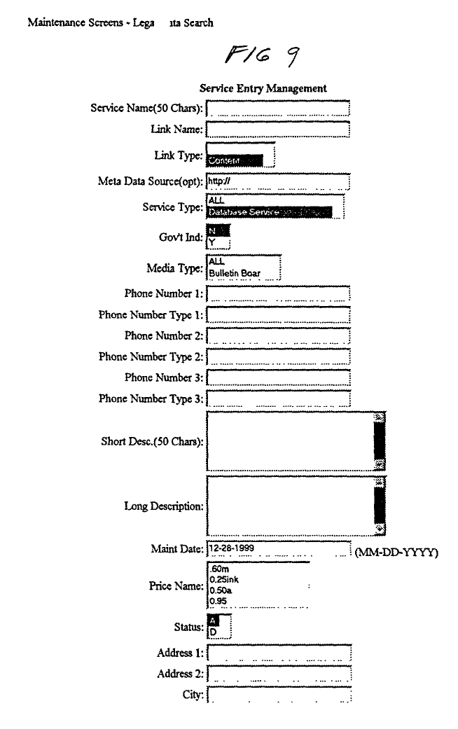

Upon entering the appropriate ID and password, the vendor is asked whether the information it will be entering is new or used (FIG. 5). If the information is a modification of existing information, the vendor is asked to select its service from a scroll-down list of services (FIG. 6). The vendor then can access and update its own information. By clicking the appropriate sub file in FIG. 7, the vendor can go directly to that sub file.

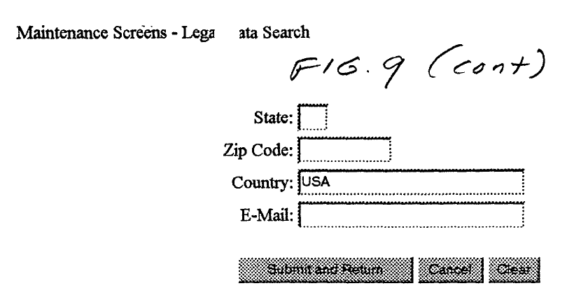

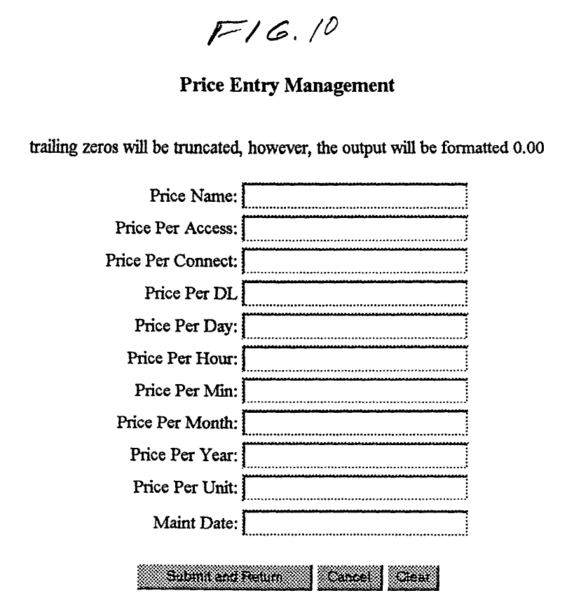

If the information is new, the vendor goes directly to the data entry management (“Back End”) screens (FIGS. 8-11) and enters information in as many fields as it desires. Sample fields shown in FIG. 8 include Database Name, date of last maintenance, link name (if applicable), short and long description, and media type. Most websites that enable a user to do research only provide information about webbased research sources. By contrast, the present invention allows the user to find databases in any type of medium, such as CD ROMs, written publications, on-line services and call-in services. The meta-index provides a filed where the vendor can enter the type of media it offers.

The system also allows the vendor to indicate the frequency of updates. This information can be very important to a legal researcher, for example, who needs to know how often a case has been updated.

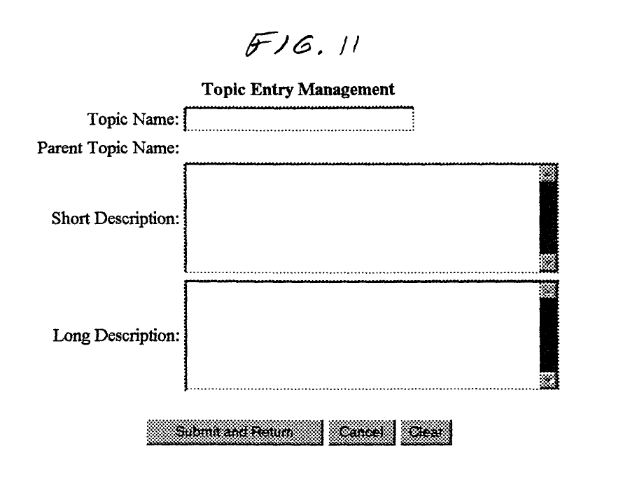

The meta-index is very comprehensive and flexible about the amount of information it contains. FIG. 9 provides an example of information relating to the vendor's phone numbers for sales, customer service and whether or not the service provider is a government agency.

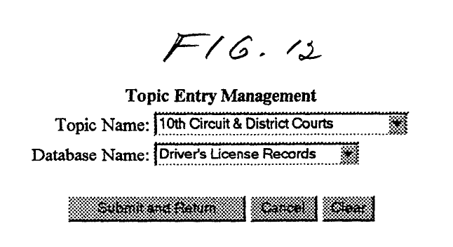

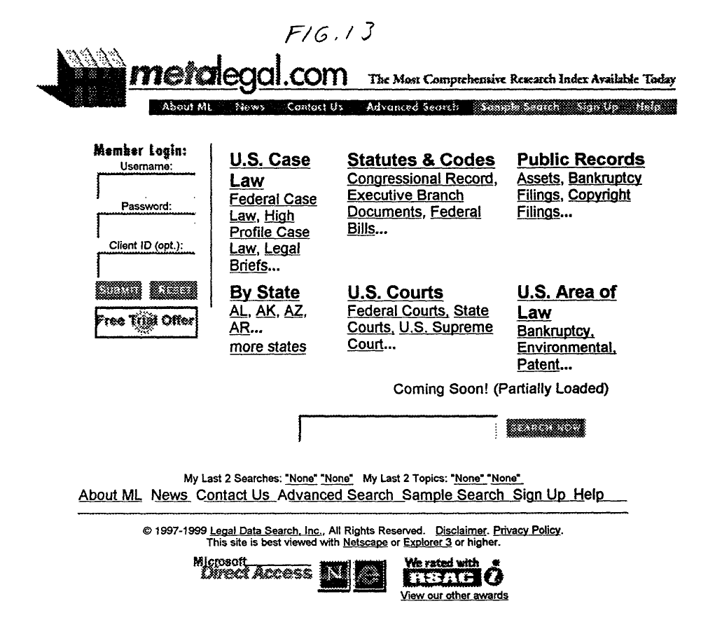

By accessing the Price Entry Management screen (FIG. 10), the vendor can provide pricing information in any form it wishes, including price per hour, price per day and price per connect. FIGS. 11 and 12 show sample Topic Entry Management screens that can be used by a vendor to indicate the general topic of the information contained in its database.

Significantly, only the vendors see these back end screens. As shown in FIGS. 8-11, a significant amount of information may be entered (or updated) by the vendor. However, the vendor need not enter all the information requested. The vendor information can be updated as often as the vendor wishes, even continually.

### Step 2 (Data Storage):

The information entered by the vendor is then stored in the Meta-Database, a relational data repository. As shown in FIG. 2, the repository comprises a number of related tables, including Service, Database and Library tables. A Topic table can be used to associate a topic and database, a topic and service, or a topic and library. For instance, the topic “Aircraft Assets” is associated with the Westlaw▪ database “Aircraft”.

### Step 3 (Maintenance):

A significant aspect of the invention is the automated vendor maintenance feature. Means are provided that enable a vendor to update its information in the Meta-Database either by manually inputting the updated information, or by automatically transferring files to the system Web Server using the File Transfer Protocol (FTP) or another standard Internet protocol.

If a vendor updates its data by automatically transferring files, then periodically, perhaps once each night, the system server loads the information from the vendor files into the Meta Database via a custom program. In this way a vendor's database information can be maintained automatically without human intervention.

### Step 4 (Reporting):

Users can access the meta-index via the Internet and then search the meta-index for databases of interest. The search can be done using topic names, keywords, vendor (source) names, source descriptions, cost, or any combination of the above. Once the desired databases are located, the user can generate a report containing vendorsupplied information about those databases (see Step 2 above), similar to the information one might find in a vendor's product catalogue.

FIGS. 13-16 show sample front end screens accessible to a user via the user's web browser. FIG. 13 is a sample of the first screen a user might encounter when accessing the system. The screen allows the user to provide a Username and Password so the user can be billed, if desired. This first screen may also indicate general topics of interest, such as U.S. Case Law, U.S. Public Records, and U.S. Statutes, Codes and Regulations. Although the illustrated embodiment shows legal related topics only, any type of topic may be the subject of a search, such as medical, scientific and market research topics.

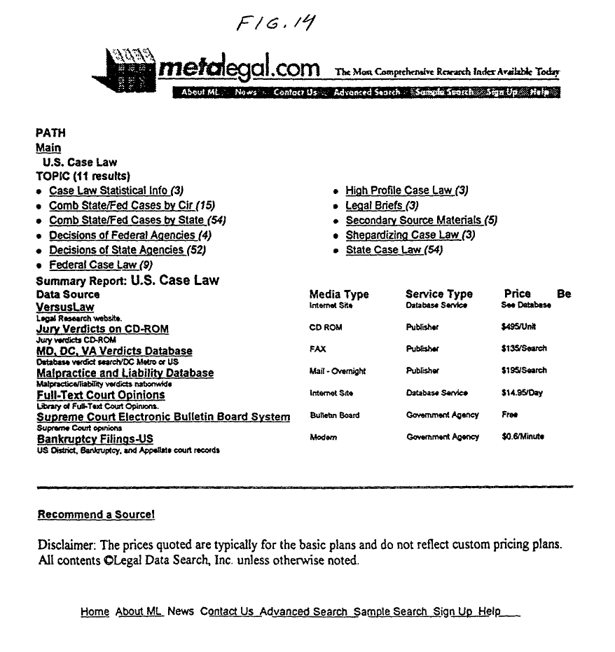

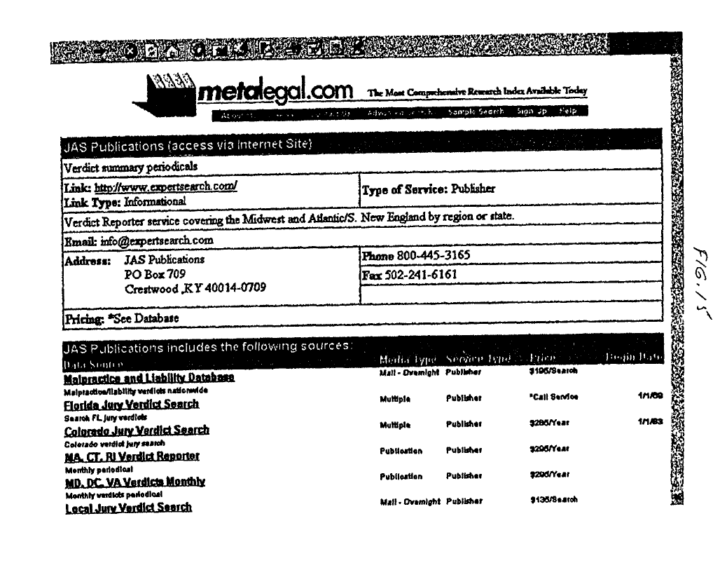

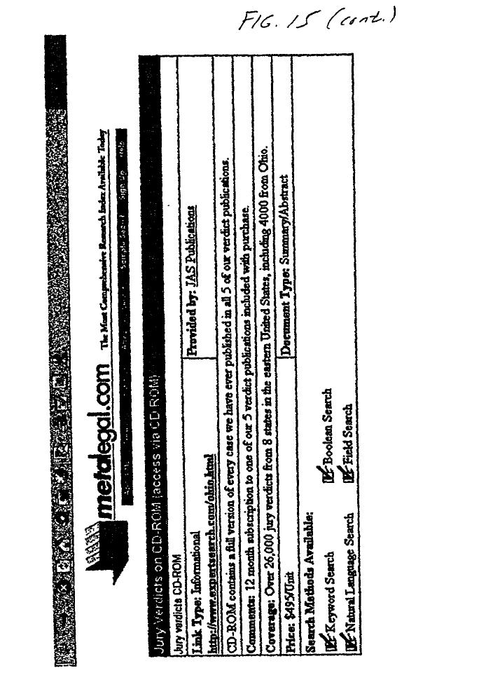

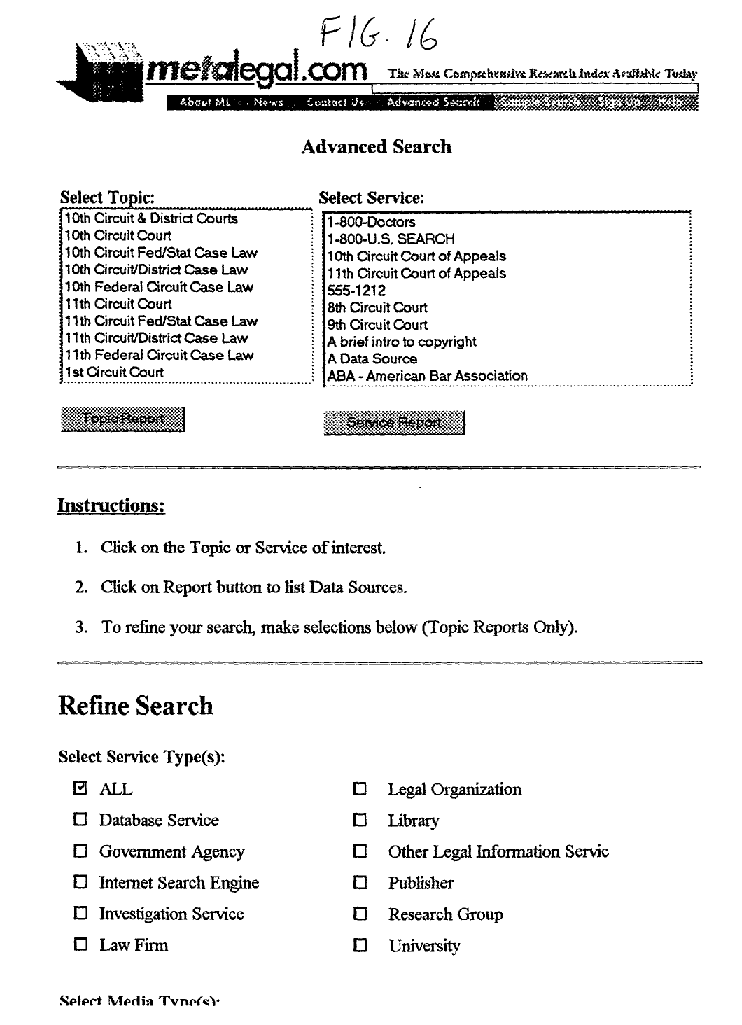

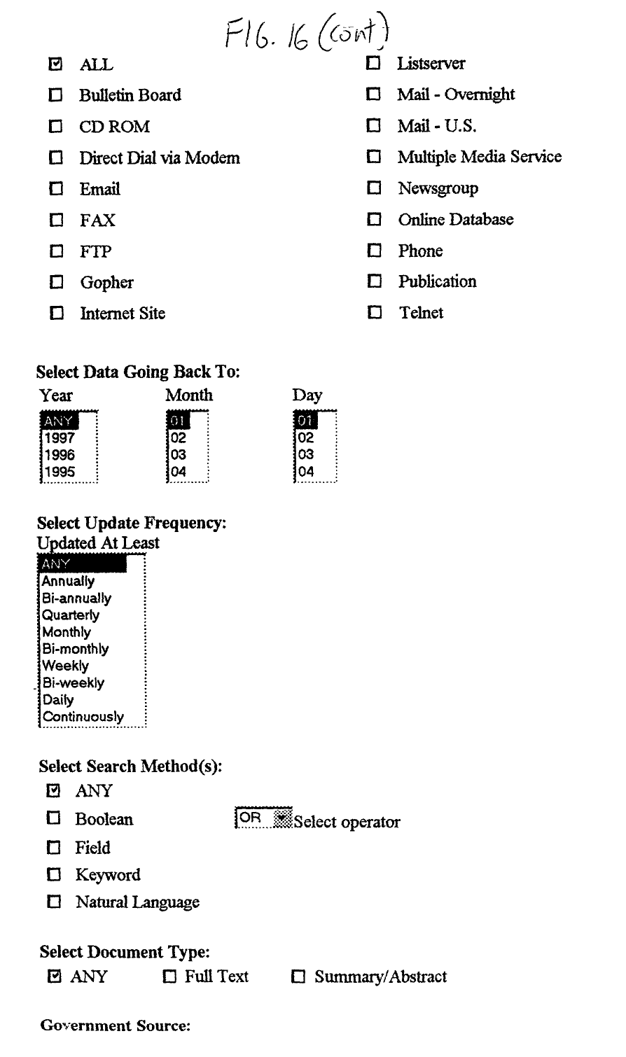

Suppose the user is interested in obtaining information about a Federal court case. The user may click on “U.S. Case Law” to bring up a Summary Report showing information on various databases relating to U.S. case law, as shown in FIG. 14. For each database shown, the system provides, in summary form, the media type, service type, price and start date. If a particular database is of interest, the user clicks on that database and obtains a Detailed Report (FIG. 15). The Detailed Report provides complete data on the information source, including update schedule, available search methods, and detailed cost information. If the Vendor that provides the database is itself of interest, the user may click on the vendor name to produce a Vendor Report (not shown), which includes the vendor's address, link name, phone number and a Summary Report of the vendor's databases.

### Advanced Search

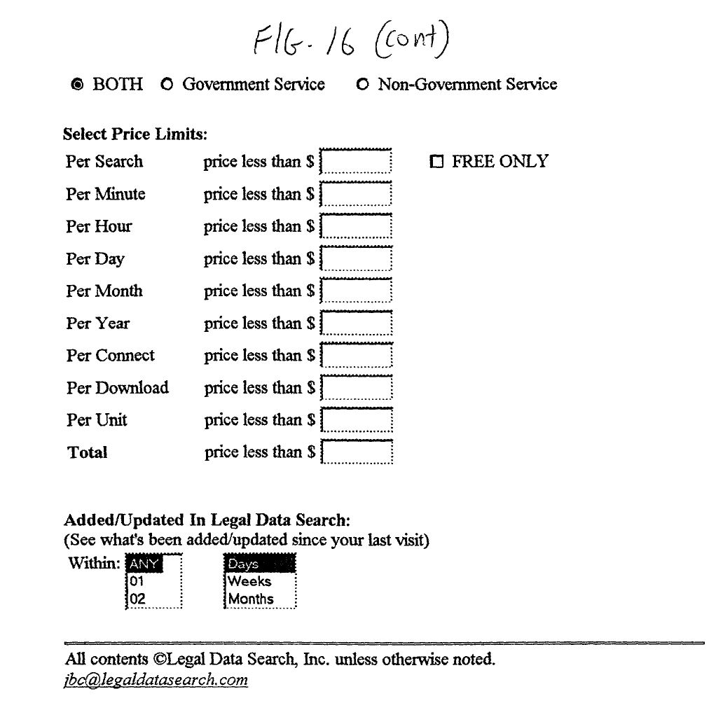

Optionally, the system enables a user to conduct an “Advanced Search” (FIG. 16). There are two kinds of advance searching a user can perform. One type is to select a topic from a scroll down alphabetical list of topics. By clicking on a topic the user can generate a Summary Report similar to that shown in FIG. 14. Alternatively, the user can select from a scroll down list of information service providers. By clicking on the name of a service provider, the user obtains a Service Report (not shown). The Service Report is similar to a service catalogue, in that it includes information on the provider's services, including type of service and price. Alternatively, the user can generate “vendor reports” from a pull down menu of vendors listed in alphabetical order.

Thus the present invention provides a shopping Web site for researchers who want comparative information about information sources (databases) within an area of interest. The system can be accessed directly by the database vendor to capture new information or update old information about a database.

In one contemplated embodiment, the meta-index will contain hyperlinks to the vendor databases, allowing the user to go directly to the desired databases from the metaindex provider's web site.

In another contemplated embodiment, users will have the option of asking the meta-index server to keep them updated on new data sources in a particular area of interest or whenever a particular database of interest has been updated.

Other modifications and alternative embodiments of the invention are contemplated which do not depart from the spirit and scope of the invention as defined by the foregoing teachings and appended claims. It is intended that the claims cover all such modifications that fall within their scope.

I claim as my invention:

1. A method of providing information about a database from a repository of database information, said method comprising the steps of:
a) enabling database vendors to enter information about their databases to a system server;
b) storing the vendor information in a relational data repository;
c) providing means by which each vendor can update only the information about the vendor's database;
d) allowing users to access the repository to search the information and obtain information about a database.

2. The method of claim 1 wherein the searchable information comprises database name, description of the database, type of media in which the database is available, frequency of updates, search methods that may be used when searching the database, type of documents contained in the database, and cost of accessing the database.

3. The method of claim 1 further comprising an automated vendor maintenance step, during which the vendor transfers a file to the system server using a standard Internet protocol, and the system server automatically loads information from the vendor files into the repository.

4. The method of claim 3 wherein the vendor information is loaded into the repository once each night.

4. A system for capturing, updating and reporting information about databases using the internet, the system comprising:
means for capturing information from a vendor about the vendor's database;
means for storing the information about the database in a repository;
means for updating the database information;
means for searching the repository for a database file;
means for reporting the information contained in the database file.

5. The system of claim 4 wherein the means for capturing information includes providing the vendor with a secure vendor password for restricting access to the vendor's database file to the vendor.

6. The system of claim 4 wherein the means for storing the database information comprises:
a database table;
a topic table which associates topic and a db together;

7. The system of claim 4 wherein the means for updating the database information comprises:
means for accessing a vendor's database file;
means for transferring the file to a server operable to receive information from the vendor;
means for reformatting the vendor database file; and means for inputting the reformatted database file into the repository.

8. The system of claim 4 wherein the means for searching the meta-database system comprises means for conducting a keyword search which creates a report of topics and databases descriptions which contain the keyword, and a topic search whereby the user drills down a hierarchy of topics and subtopics, and a summary report of databases is produced at each level.

9. The system of claim 4 wherein the reporting means comprises a hyperlink to the database which is described in the file.

10. The system of claim 4 wherein the databases are one or more database services selected from the group consisting of web-based services, CD-ROM based services, fax services, and call-in services.

11. The system of claim 4 wherein the database information includes database name, a description of the database, media type, update schedule, document types and pricing.

12. A system for capturing, storing, updating and reporting information about databases using the Internet, the system comprising:
a meta-index for storing information relating to a plurality of databases;
a server communicating with the meta-database for:
a) capturing, storing and updating information from a database vendor, the server operable to assign the vendor a unique identifier and password;
b) responding to queries received via the internet from a plurality of users for information from the meta-database; and
c) generating reports responsive to the user queries, said reports comprising vendor-supplied information about a database.

13. The system of claim 12 wherein the server further comprises means for automatically obtaining updated information from the vendor about the vendor's database and updating the meta-database with the updated information.

14. The system of claim 13 wherein the means for automatically obtaining updated information is activated once per day.

15. The system of claim 12 wherein the user queries can be made using hierarchical pull down menus.
